(19) United States
(12) Patent Application Publication
(10) Pub. No.: US 2014/0089180 A1
(43) Pub. Date: Mar. 27, 2014

(54) ELECTRONIC WALLET SERVICE SYSTEM BASED ON AN IDLE SCREEN APPLICATION

(71) Applicant: Jung Chual PARK, Goyang-si (KR)

(72) Inventor: Jung Chual PARK, Goyang-si (KR)

(73) Assignee: WON INC., Seoul (KR)

(21) Appl. No.: 14/090,163

(22) Filed: Nov. 26, 2013

Related U.S. Application Data
(63) Continuation-in-part of application No. 13/258,176, filed on Dec. 12, 2011.

(30) Foreign Application Priority Data
Mar. 26, 2009 (KR) 10-2009-0025947
Mar. 26, 2010 (KR) 10-2010-0027149

(51) Int. Cl. G06Q 20/36

(52) U.S. Cl. CPC G06Q 20/36
USPC 705/40

(57) ABSTRACT

An E-wallet service system based on an idle screen application comprising: a push system receiving a first payment request message including seller information, customer identification information, payment object information, and payment amount information from a payment request system of a seller and pushing the first payment request message to a customer terminal corresponding to the customer identification information of the first payment request message; and a customer terminal having an idle screen application which includes an e-wallet module and a payment processing module, and requesting a payment approval to a payment system via a payment approval system by performing the e-wallet module and the payment processing module.

### CROSS REFERENCE TO RELATED APPLICATIONS

This is a continuation-in-part application of U.S. patent application Ser. No. 13/258,176, filed on Dec. 12, 2011, which is a national entry of International Application No. PCT/KR2010/001871, filed on Mar. 26, 2010, which claims a priority to and the benefit of Korean Patent Application Nos. 10-2009-0025947, filed on Mar. 26, 2009, and 10-2010-0027149, filed on Mar. 26, 2010, the contents of which in their entirety are herein incorporated by reference.

### BACKGROUND

1. Field of the Invention

The present invention relates to payment service technique, and more particularly to, an E(electronic)-wallet service method and system based on an idle screen application which performs payment and payment management through an idle screen application.

2. Background of the Invention

Generally, in a payment service technique, payment is performed between a seller and a buyer by a payment system or a VAN (value added network) system. As the technique is developed, a next-generation payment system called PAYMENT 2.0 is commercialized as a user-oriented personalized payment service system which provides a payment relaying service.

Among the next-generation payment systems, a payment service called “INI P2P” is provided as a blog-based service. Since there is a limitation in the eligibility, the payment service has not yet widely used in the market. In addition, since a mobile safety service which is currently provided employs SMS (Short Message Service) for reinforcement of security and personalized payment approval, the mobile safety service can be provided through only a mobile communication terminal. Therefore, there is a convenience in that a user necessarily subscribe to a finance company in advance in order to register a payment means.

Accordingly, in the related art, a service technique capable of integrating a plurality of payment means without a complicated procedure and managing information of payment performed by a plurality of the payment means needs to be developed.

### SUMMARY OF THE INVENTION

The present invention provides an E-wallet service system based on an idle screen application capable of providing payment services

According to a first aspect of the present invention, there is provided an E-wallet service system based on an idle screen application comprising: a push system receiving a first payment request message including seller information, customer identification information, payment object information, and payment amount information from a payment request system of a seller and pushing the first payment request message to a customer terminal corresponding to the customer identification information of the first payment request message; and a customer terminal having an idle screen application which includes an e-wallet module and a payment processing module, and requesting the payment approval to a payment system via a payment approval system by performing the e-wallet module and the payment processing module.

In the system according to the first aspect, it is preferable that the e-wallet module is activated when the first payment request message is pushed from the push system and displays the first payment request message on a screen; the payment processing module is inputted payment medium information if payment according to the first payment request message is requested, is inputted a password corresponding to the inputted payment information, generates a second payment request message and transmits the second payment request message to a payment system via a payment approval system; and the second payment request message includes the payment medium information, the password, the payment object information, and the payment amount information.

According to a second aspect of the present invention, there is provided an E-wallet service system based on an idle screen application comprising: a push system receiving a first payment request message including seller information, customer identification information, payment object information, and payment amount information from a payment request system of a seller, pushing the first payment request message to a customer terminal corresponding to the customer identification information of the first payment request message, and when an authorization to a payment medium is requested by the customer terminal, performs the authorization, generates a virtual card number and provides the virtual card number to the customer terminal and a payment system; a customer terminal being installed an idle screen application which includes an e-wallet module and a payment processing module, and requesting the payment approval by performing the e-wallet module and the payment processing module to a payment system via a payment approval system; and a payment system, when a payment approval is requested from the customer terminal, compares the virtual card number provided from the customer terminal and the virtual card number provided from the push system, performs the payment approval according to the compared result, and provides the payment approval result to the customer terminal via the payment approval system.

In the system according to the second aspect, it is preferable that the e-wallet module is activated when the first payment request message is pushed from the push system and displays the first payment request message; the payment processing module is inputted payment medium information if payment according to the first payment request message is requested, is inputted a password corresponding to the inputted payment medium information, generates a second payment request message and transmits the second payment request message to the payment system via the payment approval system; and the second payment request message includes the payment medium information, the virtual card number, the payment object information, and the payment amount information.

### BRIEF DESCRIPTION OF THE DRAWINGS

FIG. 1 is a diagram illustrating a configuration of an E-wallet service system based on an idle screen application according to the present invention.

FIGS. 2 and 3 are flowcharts of an E-wallet service method based on an idle screen application according to a first embodiment of the present invention.

FIG. 4 is a diagram illustrating an E-wallet service based on an idle screen application providing screens according to the first embodiment of the present invention.

FIG. 5 is a flowchart of an E-wallet service method based on an idle screen application according to the second embodiment of the present invention.

FIG. 6 is a diagram illustrating a configuration of an E-wallet service system based on an idle screen application according to the third embodiment of the present invention.

### DETAILED DESCRIPTION

### First Embodiment

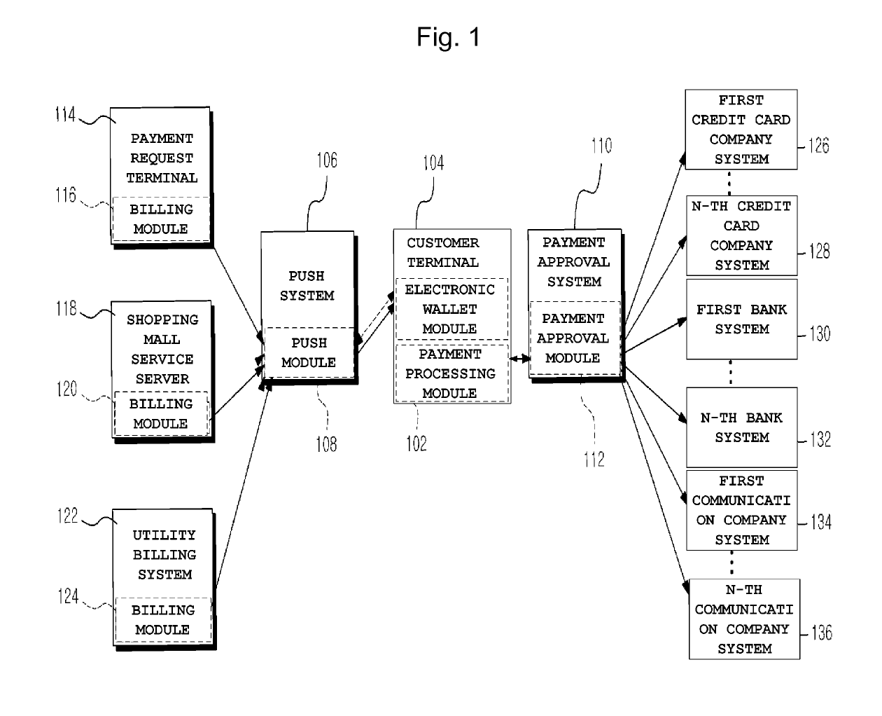

A configuration of an E-wallet service system based on an idle screen application according to the first and the second embodiments of the present invention will be described in detail with reference to FIG. 1.

The E-wallet service system based on an idle screen application includes an electronic wallet module 100, a payment processing module 102, a push module 108, billing modules 116, 120, and 124, and a payment approval module 112. The electronic wallet module 100 and the payment processing module 102 are configured based on an idle screen application according to the present invention.

The billing module 116, 120, and 124 is installed in one of the payment request systems which are a payment request terminal 114 and a shopping mall service server 118 of the seller, a utility billing system 122, and the like.

According to the present invention, the billing module 116, 120, 124 generates first payment request messages including seller information, customer identification information, payment object information, payment amount information, and the like which are input by users of the payment request systems transmits the first payment request messages to the push module 108 installed in a push system 106. In other words, the first payment request message includes seller information, customer identification information, payment object information, and payment amount information.

The push module 108 is installed in the push system 106.

According to the present invention, if the first payment request message is received from one of the billing modules 116, 120, and 124, the push module 108 extracts the customer identification information from the first payment request message, and the push module 108 pushes the first payment request message to an electronic wallet module 100 installed in a customer terminal 104 corresponding to the customer identification information.

The customer means the purchaser who should be pay for something to the seller.

In addition, the push system 106 stores electronic wallet modules and payment processing modules as idle screen applications having various skins. One of the stored electronic wallet modules and payment processing modules could be downloaded to the customer terminal 104. The electronic wallet modules may be downloaded at a charge.

In addition, the push system 106 includes an electronic coupon and gift certificate information, which is generated in an image format or various electronic formats, and allows the electronic coupon and the gift certificate information to be downloaded to the customer terminal 104.

In addition, the push system 106 manages customer account information of a customer terminal such as position information, customer identification information (ID), customer terminal identification information (for example, phone number), customer terminal specification information, login information, first payment request messages, and payment approval results, and the customer account information is provided to a customer who accesses a web through the web account.

The electronic wallet module 100 and the payment processing module 102 are idle screen applications which are downloaded from the push system 106 to be installed in the customer terminal 104. The electronic wallet module 100 and the payment processing module 102 are installed in the customer terminal 104 such as a personal computer, a mobile communication terminal, or a mobile terminal which can be connected to the push system 106 and the payment approval system 110 via wired or wireless network.

According to the present invention, the electronic wallet module 100 receives and stores the first payment request message pushed by the push module 108 of the push system 106, receives and stores a payment approval result transmitted from the payment processing module 102, selects one of the first payment request messages according to customer's request to request the payment processing module 102 to perform payment approval, receives and stores a payment approval result returned from the payment processing module 102, and edits the first payment request message and the payment approval result according to user's editing request.

According to the first and second embodiments of the present invention, the payment processing module 102 generates a second payment request message by adding the payment medium information to the payment request item selected according to the customer's request through the electronic wallet module 100 and provides the second payment request message to the payment approval module 112. If the payment approval result information is supplied through the payment approval module 112, the payment processing module 102 supplies the payment approval result information to the electronic wallet module 100. The payment medium information is information on a credit card or a banking account or information for addition of communication fees or the like. The payment medium information may be input by a customer every payment time. In addition, a plurality of the payment medium information items may be previously registered in a storage medium, a USIM (Universal Subscriber Identity Module), or the like of the customer terminal, and after that, one of the payment medium information items may be selected by the customer. In other words, the second payment request message includes the payment medium information, the customer identification information, the payment object information, and payment amount information,

The payment approval module 112 is installed in the payment approval system 110.

According to the first and second embodiments of the present invention, if the second payment request message is received, the payment approval module 112 generates a third payment request message in a sales check (slip) format corresponding to the payment medium information included in the second payment request message and transmits the generated third payment request message to a payment system corresponding to the payment medium to request payment approval.

The payment system is one of the credit card company systems 126 to 128, one of the bank systems 130 to 132, or one of the communication company systems 134 to 136

If information on a payment approval result is supplied from the payment system, the payment approval module 112 transmits the payment approval result to the payment processing module 102 of the customer terminal 104. In other words, the payment approval module 112 allows different sales check (slip) formats according to the payment medium information to be compatible.

In addition, in the above examples, although the case where the payment system is requested to perform the payment approval through the payment approval system 110 is exemplified, the payment processing module 102 may directly generate a third payment request message in a sales check (slip) format corresponding to the payment medium to request the payment system to perform the payment approval.

In addition, according to the present invention, although the case where the electronic wallet service system is configured with two different hardware components, that is, the push system 106 and the payment approval system 110 is exemplified, the electronic wallet service system may be configured with one hardware component according to the convenience of a service provider.

In addition, according to the present invention, although the case where the push system 106 is configured to download the electronic wallet module 100 is exemplified, a separate management server may be configured to download the electronic wallet module 100.

Now, first and second embodiments of the operations of the idle screen application based electronic wallet service system configured as described above will be described in detail.

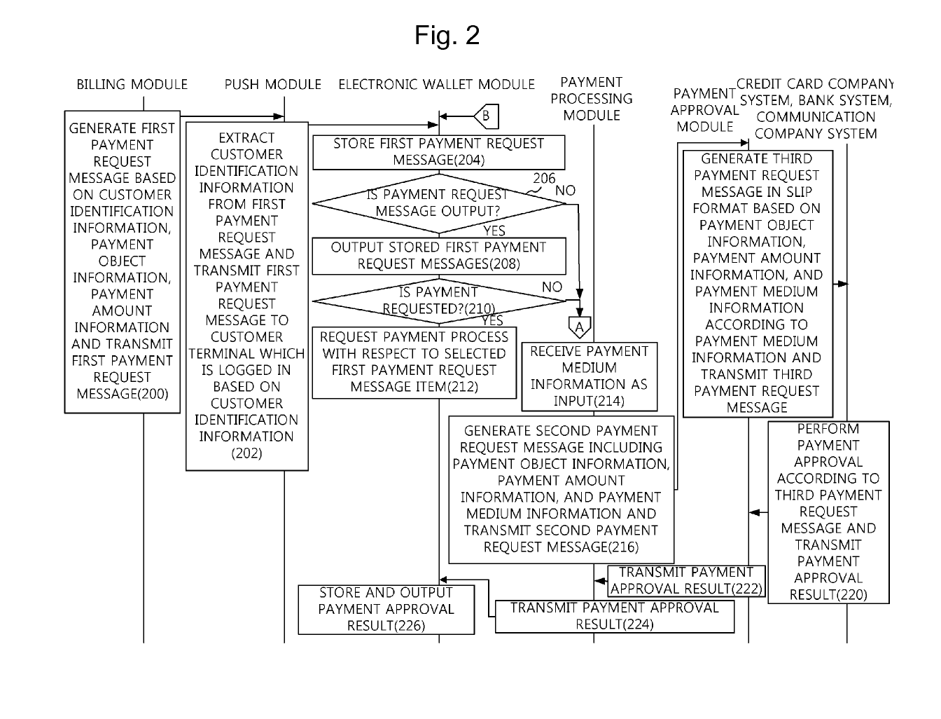

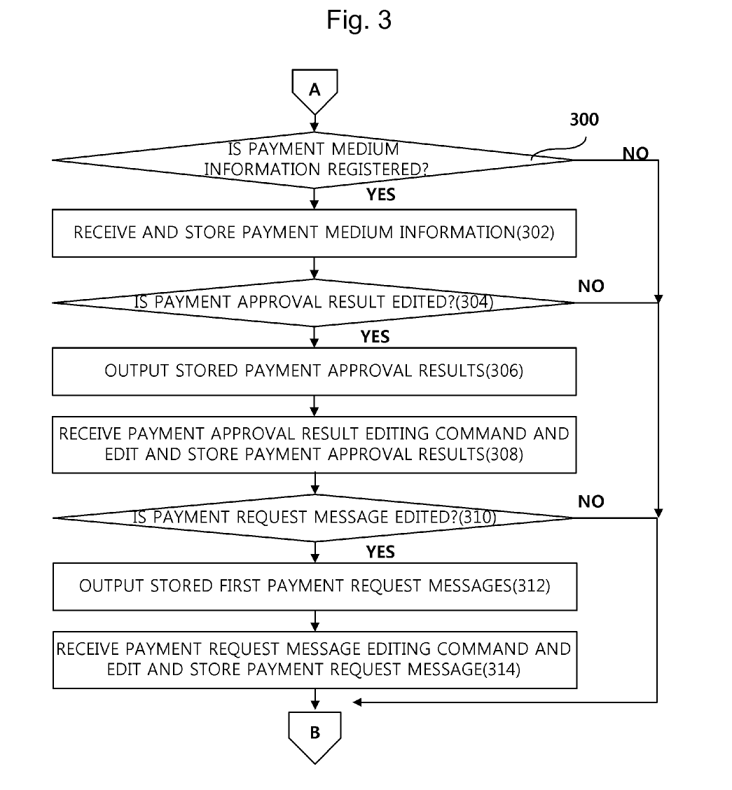

The E-wallet service method based on an idle screen application according to a first embodiment of the present invention is described with reference to flowcharts of FIGS. 2 and 3.

One of the billing modules 116, 120, and 124 generates a first payment request message including seller information, customer identification information, payment object information, and payment amount information for payment request and transmits the first payment request message to the push module 108 (Step S200).

The push module 108 extracts the customer identification information from the first payment request message and transmits the received first payment request message to the electronic wallet module 100 of the customer terminal which is logged in by the customer identification information (Step S202). Herein, in the case where the customer terminal which is logged in by the customer identification information is not present, the push module 108 transmits a notice of the reception of the first payment request message through an SMS(Short Message Service) server (not shown) or a push notification server (not shown) to the customer terminal of the customer which is registered in advance. If the customer logs in according to the notice, the push module 108 transmits the received first payment request message to the electronic wallet module 100 of the customer terminal which the customer is logged in.

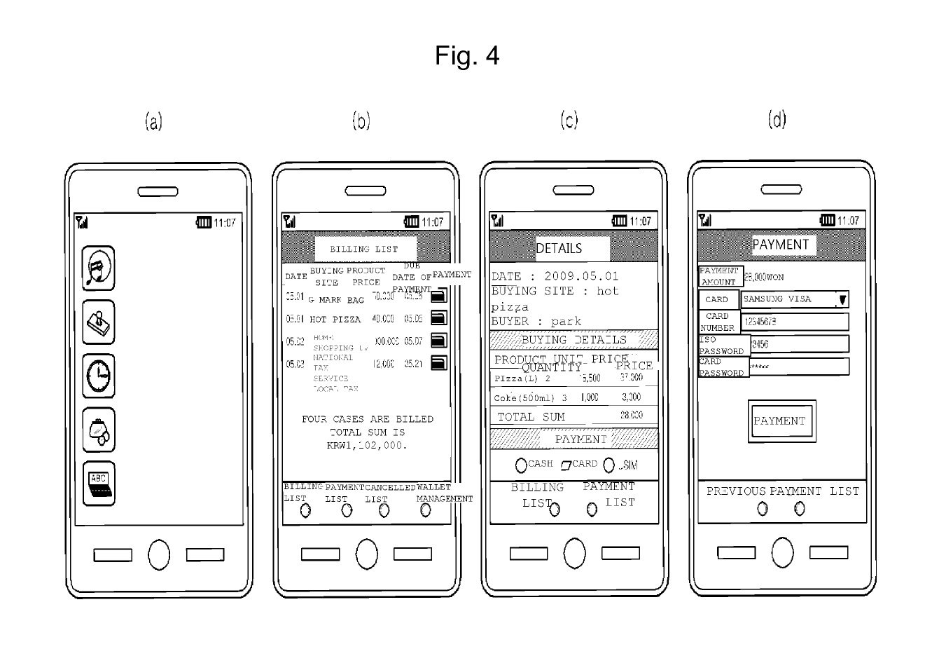

If the first payment request message is received, the electronic wallet module 100 stores the first payment request message and outputs a notice indicating that a new first payment request message is received to a display unit (Step S204). Herein, (a) of FIG. 4 illustrates a screen informing an icon of the electronic wallet module 100 and a notice indicating that a first payment request message is received.

If the output of the payment request message is requested by the customer, the electronic wallet module 100 outputs the stored first payment request messages (Steps S206 and S208). Herein, (b) of FIG. 4 illustrates a screen informing the received first payment request messages.

In the state where the items of the first payment request messages are output, if the customer selects one of the first payment request messages and the payment is requested, the electronic wallet module 100 requests the payment processing module 102 to perform a payment process for the selected item of the first payment request message (Steps S210 and S212). Herein, (c) of FIG. 4 illustrates a screen informing detailed information when the customer selects one of the first payment request messages.

If the payment request occurs, the payment processing module 102 receives the payment medium information or allows one of the payment medium information registered in advance in a USIM (Universal Subscriber Identity Module) or an internal memory to be received and generates a second payment request message including the payment object information, the payment amount information, and the payment medium information and transmits the second payment request message to the payment approval module 112 installed in the payment approval system 110 (Steps S214 and S216). Herein, (d) of FIG. 4 illustrates a screen informing that the customer selects a payment medium for the first payment request message and requests for payment.

If the second payment request message is received, the payment approval module 112 generates a third payment request message in a sales check (slip) format based on the payment object information, the payment amount information, and the payment medium information and transmits the third payment request message to a payment system according to the payment medium information (Step S218).

The payment system performs payment approval according to the third payment request message and transmits a payment approval result as a reply to the payment approval module 112 (Step S220).

The payment approval module 112 transmits the payment approval result to the payment processing module 102, and the payment processing module 102 transmits the payment approval result to the electronic wallet module 100 (Step S222 and S224).

The electronic wallet module 100 stores the payment approval result and outputs the payment approval result to inform it to the customer (Step S226).

In addition, the electronic wallet module 100 receives and stores the payment medium information according to a request for payment medium information registration issued by the customer (Steps S300 and S302). A plurality of the registered payment medium information is stored in the electronic wallet module 100, so that any one of the payment medium can be selected by the customer.

In addition, the electronic wallet module 100 outputs the stored results of the payment approval according to a request for editing the payment approval result. The electronic wallet module 100 receives editing information such as removing and changing of the payment approval results and performs the editing the payment approval results according to the editing information. The electronic wallet module 100 stores the result of the editing (Steps S304 to S308).

In addition, the electronic wallet module 100 outputs the stored first payment request message according to a request for the editing of the payment request message. The electronic wallet module 100 receives editing information such as removing or changing of the first payment request messages and performs editing the first payment request message according to the editing information. The electronic wallet module 100 stores the result of the editing (Steps S310 to S314).

### Second Embodiment

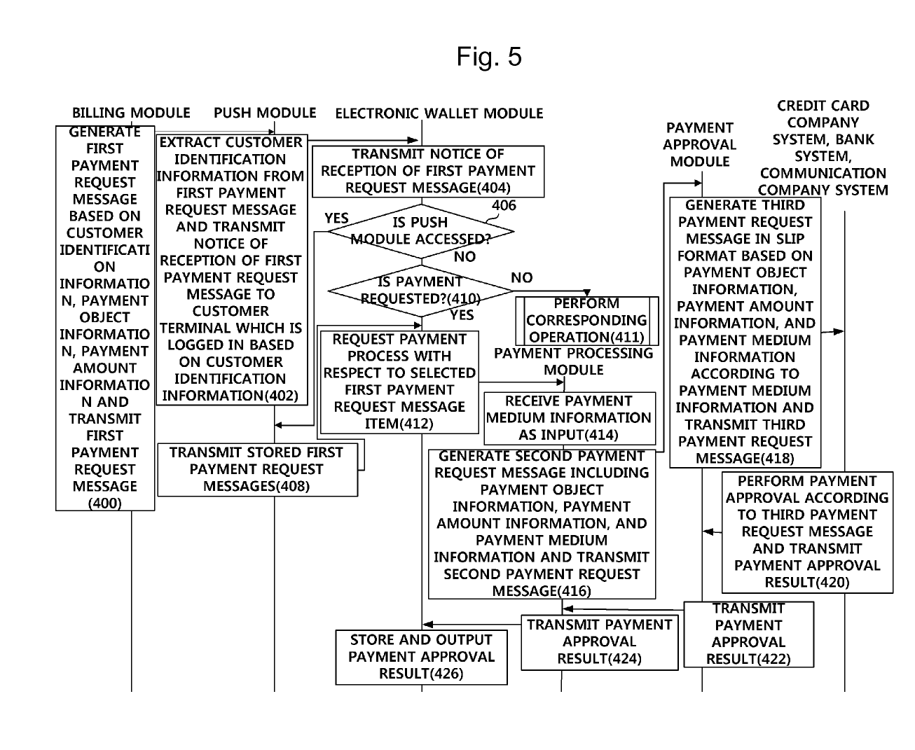

The electronic wallet service method based on an idle screen application according to a second embodiment of the present invention is described with reference to a flowchart of FIG. 5.

According to the second embodiment of the present invention, if the push module 108 of the push system 106 supplies the first payment request message notice information through an SMS(Short Message Service) server or an push notification server, the electronic wallet module 100 displays the first payment request message notice information on a screen, the electronic wallet module 100 accesses the web account of the user provided by the push module 108 according to user's request, receives and stores the first payment request messages transmitted from the push module 108, selects one of the first payment request messages according to customer's request to request the payment processing module 102 to perform payment approval. The electronic wallet module 100 receives and stores a payment approval result returned from the payment processing module 102 and edits the first payment request message and the payment approval result according to user's editing request.

One of billing modules 116, 120, and 124 generates a first payment request message including seller information, customer identification information, payment object information, and payment amount information for payment request and transmits the first payment request message to a push module 108 (Step S400).

The push module 108 extracts customer identification information from the first payment request message and transmits a notice of reception of the first payment request message to the customer terminal registered so as to correspond to the customer identification information (Step S402). The transmission of the notice is performed through an SMS(Short Message Service) server (not shown) or a push notification server (not shown).

The electronic wallet module 100 which receives the notice of reception of the first payment request message displays the notice on the screen so that a customer receives a notice of the reception of the first payment request message (Step S404). As illustrated in (a) of FIG. 4, the notice of the reception may be implemented by displaying the number of the received messages in the vicinity of the electronic wallet driving icon.

If the customer who receives the notice of the reception of the first payment request message requests accessing the push module 108, the electronic wallet module 100 accesses a web account of the customer included in the push module 108 to request a list of the first payment request messages of the customer and receives the list of the first payment request messages (Steps S406 and S408). Herein, the access to the push module 108 may be performed by user double-clicking the electronic wallet driving icon.

Next, the electronic wallet module 100 receives the first payment request messages, and if the customer selects one of the first payment request messages to perform request for payment under the state where the first payment request message items are output, the electronic wallet module 100 requires the payment processing module 102 to perform the payment process with respect to the selected first payment request message item (Steps S410 and S412).

If the payment request occurs, the payment processing module 102 receives the payment medium information as an input or selects one of the payment medium information which is registered in advance in the USIM (Universal Subscriber Identity Module) or the internal memory, generates the second payment request message including the payment object information, the payment amount information, and the payment medium information, and transmits the second payment request message to the payment approval module 112 (Steps S414 and S416).

If the second payment request message is received, the payment approval module 112 generates a third payment request message in the sales check (slip) format according to the payment medium information based on the payment object information, the payment amount information, and the payment medium information and transmits the third payment request message the payment system according to the payment medium information (Step S418).

The payment system performs the payment approval according to the third payment request message and returns the result thereof to the payment approval module 112 (Step S420).

The payment approval module 112 transmits the payment approval result to the payment processing module 102, and the payment processing module 102 transmits the payment approval result to the electronic wallet module 100 (Steps S422 and S424).

The electronic wallet module 100 outputs the payment approval result to present the result to the customer (Step S426).

### Third Embodiment

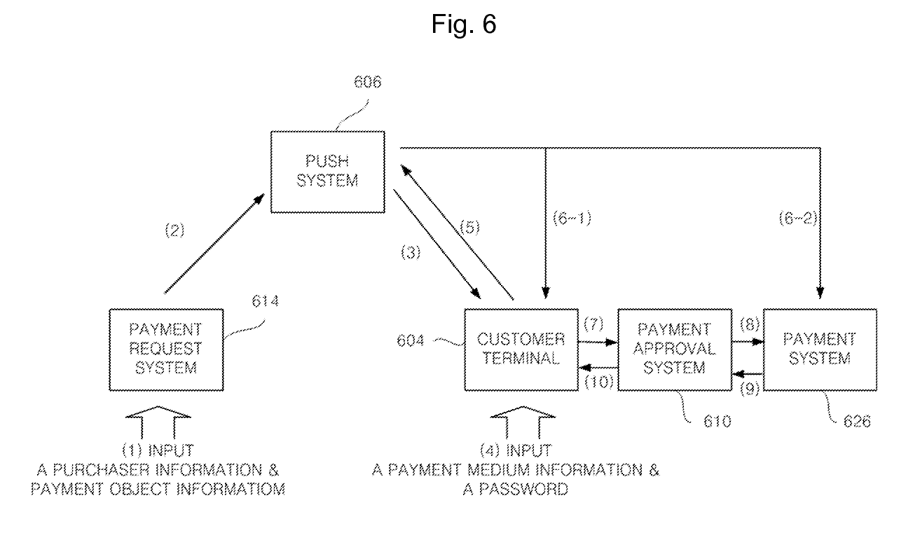

A configuration of an E-wallet service system based on an idle screen application according to the third embodiment of the present invention will be described in detail with reference to FIG. 6.

The E-wallet service system based on an idle screen application according to the third embodiment of the present invention includes an electronic wallet module and a payment processing module of a customer terminal 604, a push module of a push system 606, a billing module of payment request system 614, and a payment approval module of a payment approval system 610 and a payment system 626. The electronic wallet module and the payment processing module are configured based on an idle screen application according to the present invention.

The billing module is installed in the payment request system 614. The payment request system is one of a payment request terminal and a shopping mall service server of the seller, a utility billing system, and the like.

According to the third embodiment of the present invention, the billing module generates first payment request messages including seller information, customer identification information, payment object information, payment amount information, and the like which are input by users of the payment request system transmits the first payment request messages to the push system 606. In other words, the first payment request message includes seller information, customer identification information, payment object information, and payment amount information.

The push module is installed in the push system 606.

According to third embodiment of the present invention, if the first payment request message is received from the billing module, the push module assigns a unique purchasing number to the first payment request message, extracts the customer identification information from the first payment request message, and pushes the first payment request message and the unique purchasing number to an electronic wallet module in a customer terminal 604 corresponding to the customer identification information.

According to the third embodiment of the present invention, the push system 606 saves and manages the payment medium information of the registered customer and the authorization information of the payment medium. The authorization information may be a password of a credit card, etc.

Therefore, when an authorization of the payment medium is requested, the push system performs the authorization of the payment medium. If the authorization is succeeded, the push system generates a virtual card number, and pushes it to the customer's terminal and provides it to the payment system.

According to the third embodiment of the present invention, if a payment approval is requested from the customer terminal, the payment system compares the virtual card number provided from the customer terminal and the virtual card number provided from the push system. If the virtual card numbers are same each other, the payment system approves the payment and provides the payment approval result to the customer terminal via the payment approval system.

Now, the operations of the electronic wallet service system based on the idle screen application according to the third embodiment of the present invention configured as described above will be described in detail with reference to a block diagram of FIG. 6.

The billing module of the payment request system 614 is input purchaser information and payment information (Step 1).

The billing module generates a first payment request message including seller information, customer identification information, payment object information, and payment amount information for payment request and transmits the first payment request message to the push module of the push system (Step 2).

The push module assigns a unique purchasing number to the first payment request message, extracts the customer identification information from the first payment request message and transmits the received first payment request message along with the unique purchasing number to the electronic wallet module of the customer terminal which is logged in by the customer identification information (Step 3). Herein, in the case where the customer terminal which is logged in by the customer identification information is not present, the push module transmits a notice of the reception of the first payment request message through an SMS (Short Message Service) server (not shown) or a push notification server (not shown) to the customer terminal of the customer which is registered in advance. If the customer logs in according to the notice, the push module transmits the received first payment request message to the electronic wallet module of the customer terminal which the customer is logged in.

If the first payment request message is received, the electronic wallet module stores the first payment request message and the unique purchasing number and displays the first payment request message on a screen.

If the payment is requested by the customer, the electronic wallet module requests the payment processing module to perform a payment process for the first payment request message.

If the payment request occurs, the payment processing module is input the payment medium information and a password corresponding to the inputted payment medium information (step 4), and provides the payment medium information and the password and requests to perform the authorization of the provided payment medium to the push system 606(step 5).

If the push system is requested the authorization by the payment processing module of the customer terminal, the push system performs the authorization to the payment medium and then, when the authorization is succeeded, generates a virtual card number and provides the virtual card number to the payment processing module and the payment system corresponding to the payment medium (step 6-1 and 6-2).

If the virtual card number is received from the push system, the payment processing module of the customer terminal generates a second payment request message including the payment object information, the payment amount information, the payment medium information and the virtual card number, and transmits the second payment request message to the payment approval module of the payment approval system 610 (Step 7).

If the second payment request message is received, the payment approval module generates a third payment request message in the a sales check (slip) format based on the second payment request message according to the payment medium information and transmits the third payment request message to a payment system according to the payment medium information (Step 8).

The payment system performs payment approval according to the third payment request message by comparing the virtual card number in the third payment request message and the virtual card number provided from the push system, and then transmits a payment approval result as a reply to the payment approval module (Step 9).

The payment approval module transmits the payment approval result to the payment processing module (Step 10), and the payment processing module transmits the payment approval result to the electronic wallet module.

The electronic wallet module stores the payment approval result and outputs the payment approval result to inform the customer.

What is claimed is:

1. An E-wallet service system based on an idle screen application comprising:
a push system receiving a first payment request message including seller information, customer identification information, payment object information, and payment amount information from a payment request system of a seller and pushing the first payment request message to a customer terminal corresponding to the customer identification information of the first payment request message; and
a customer terminal having an idle screen application which includes an e-wallet module and a payment processing module, and requesting the payment approval to a payment system via a payment approval system by performing the e-wallet module and the payment processing module,
wherein the e-wallet module is activated when the first payment request message is pushed from the push system and displays the first payment request message on a screen,
wherein the payment processing module is inputted payment medium information if payment according to the first payment request message is requested, is inputted a password corresponding to the inputted payment information, generates a second payment request message and transmits the second payment request message to a payment system via a payment approval system, and
wherein the second payment request message includes the payment medium information, the password, the payment object information, and the payment amount information.

2. The E-wallet service system based on an idle screen application according to claim 1,
wherein, when the idle screen application is installed in the customer terminal, the push system registers the customer identification information, generates an application key corresponding to the installed idle screen application, and provides the application key and the customer identification information to the payment system.

3. The E-wallet service system based on an idle screen application according to claim 1,
wherein the payment processing module stores the first payment request message and the payment approval result and removes or changes the stored first payment request message and the stored payment approval result according to user's request for removal or change.

4. The E-wallet service system based on an idle screen application according to claim 1,
wherein the idle screen application is downloaded from the push system or a predetermined management server to be installed in the customer terminal.

5. The E-wallet service system based on an idle screen application according to claim 1,
wherein the push system downloads an electronic coupon or a gift certificate to the customer terminal,
wherein the payment processing module allows the electronic coupon or the gift certificate to be viewed or allows payment amount to be discounted.

6. The E-wallet service system based on an idle screen application according to claim 1,
wherein the payment medium information is stored and registered in a USIM (Universal Subscriber Identity Module) or an internal memory of the customer terminal.

7. The E-wallet service system based on an idle screen application according to claim 1,
wherein the push system transmits a notice of reception of the payment request message to the customer terminal through an SMS(Short Message Service) server or a push notification server.

8. The E-wallet service system based on an idle screen application according to claim 1,
wherein the customer terminal registers and manages at least one or more payment medium information, and
wherein the payment processing module is inputted the payment medium information as selecting one of the registered payment medium information.

9. The E-wallet service system based on an idle screen application according to claim 1,
Wherein, when the second payment request message from the customer terminal is received, the payment approval system generates a third payment request message in a sales check (slip) format corresponding to the payment medium information of the second payment request message, transmits the third payment request message to the payment system and requests to perform the payment approval.

10. An E-wallet service system based on an idle screen application comprising:
a push system receiving a first payment request message including seller information, customer identification information, payment object information, and payment amount information from a payment request system of a seller, pushing the first payment request message to a customer terminal corresponding to the customer identification information of the first payment request message, and when an authorization to a payment medium is requested by the customer terminal, performs the authorization, generates a virtual card number and provides the virtual card number to the customer terminal and a payment system;
a customer terminal being installed an idle screen application which includes an e-wallet module and a payment processing module, and requesting the payment approval by performing the e-wallet module and the payment processing module to a payment system via a payment approval system; and
a payment system, when a payment approval is requested from the customer terminal, compares the virtual card number provided from the customer terminal and the virtual card number provided from the push system, performs the payment approval according to the compared result, and provides the payment approval result to the customer terminal via the payment approval system,
wherein the e-wallet module is activated when the first payment request message is pushed from the push system and displays the first payment request message,
wherein the payment processing module is inputted payment medium information if payment according to the first payment request message is requested, is inputted a password corresponding to the inputted payment medium information, generates a second payment request message and transmits the second payment request message to the payment system via the payment approval system, and
wherein the second payment request message includes the payment medium information, the virtual card number, the payment object information, and the payment amount information.

11. The E-wallet service system based on an idle screen application according to claim 10,
wherein, when the idle screen application is installed in the customer terminal, the push system registers the customer identification information, generates an application key according to the installed idle screen application, and provides the application key and the customer identification information to the payment system.

12. The E-wallet service system based on an idle screen application according to claim 10,
wherein the payment processing module stores the first payment request message and the payment approval result and removes or changes the stored first payment request message and the stored payment approval result according to user's request for removal or change.

13. The E-wallet service system based on an idle screen application according to claim 10,
wherein the idle screen application is downloaded from the push system or a predetermined management server to be installed in the customer terminal.

14. The E-wallet service system based on an idle screen application according to claim 10,
wherein the push system downloads an electronic coupon or a gift certificate to the customer terminal,
wherein the payment processing module allows the electronic coupon or the gift certificate to be viewed or allows payment amount to be discounted.

15. The E-wallet service system based on an idle screen application according to claim 10,
wherein the payment medium information is stored and registered in a USIM (Universal Subscriber Identity Module) or an internal memory of the customer terminal.

16. The E-wallet service system based on an idle screen application according to claim 10,
wherein the push system transmits a notice of reception of the payment request message to the customer terminal through an SMS(Short Message Service) server or a push notification server.

17. The E-wallet service system based on an idle screen application according to claim 10,
wherein the customer terminal registers and manages at least one or more payment medium information, and
wherein the payment processing module is inputted the payment medium information as selecting one of the registered payment medium information.

18. The E-wallet service system based on an idle screen application according to claim 10,
Wherein, when the second payment request message from the customer terminal is received, the payment approval system generates a third payment request message in a sales check (slip) format corresponding to the payment medium information of the second payment request message, transmits the third payment request message to the payment system and requests to perform the payment approval.
